(19) United States
(12) Patent Application Publication
(10) Pub. No.: US 2022/0076208 A1
(43) Pub. Date: Mar. 10, 2022

(54) METHODS AND SYSTEMS FOR PROCESSING TRAINING RECORDS AND DOCUMENTS OF EMPLOYEES

(71) Applicant: Scopeasy Construction Software Limited, Dublin (IE)

(72) Inventor: Padraig REILLY, Cascais (IE)

(21) Appl. No.: 17/465,692

(22) Filed: Sep. 2, 2021

Related U.S. Application Data
(60) Provisional application No. 63/074,601, filed on Sep. 4, 2020.

(51) Int. Cl. G06Q 10/10; G06K 9/00; G06F 16/93; G06F 3/0482

(52) U.S. Cl. CPC G06Q 10/105; G06K 9/00469; G06K 2209/01; G06F 3/0482; G06F 16/93

(57) ABSTRACT

Various embodiments of the present disclosure provide methods and systems for managing documents associated with each employee. The method performed by an application server includes receiving the documents associated with an employee of a workplace through a document management application available in a user device associated with an employee admin of the workplace. The method includes extracting a first set of data attributes from the documents using one or more character recognition techniques. The method further includes displaying of the first set of data attributes entered in corresponding data fields rendered in the document management application. Further, the method includes receiving a second set of data attributes based on inputs provided by the employee admin in corresponding data fields rendered in the document management application. The method includes generating a user profile for the employee in the document management application based on the first and second set of data attributes.

### TECHNICAL FIELD

The present disclosure relates to human resource management and, more particularly relates, to methods and systems for efficiently capturing, tracking, processing, and managing training records and documents such as a work license, worksite specific training, tickets, qualifications, and associated training certificates with employees at a workplace.

### BACKGROUND

Document collection and organization in industries, worksites, companies, etc., is a prime role for human resource and general management. With traditional paper-based systems or manual data entry methods, the documents and information collected from workers may often get lost, error-prone or difficult to account for. The conventional paper-based systems and methods result in a time-consuming process, are error-prone, and may require additional resources and human capital to manage the workers' records. Moreover, poor safety performance caused in part by poor record-keeping of the training and work site-specific records and documents can lead to fines and prosecutions and increase a company's safety risk.

Due to the advent of technology, various workflow solutions and document management systems have been developed to manage the workers' records and documents of a worksite. In this scenario, a user (e.g., an admin or a manager of a workplace) uploads the documents or records of the workers in the document management systems in an electronic format (e.g., a portable document format (PDF)). However, the currently available document management systems possess limitations such as being unable to identify or classify documents, being unable to extract relevant data from the documents and involving manual processing of records and documents that can be time-consuming and expensive. Thus, the currently available document management systems lack sophistication and real-world usability. Moreover, presently available systems require the user to manually input key information contained in documents through human effort inputting into computer systems.

Therefore, there is a need for a document management system and method to automate data capturing of the workers' documents at the workplace and provide other technical advantages. Also, due to the nature of carrying out worksite-specific training in a bespoke manner, there is a need to convert an infinite number of bespoke formats of worksite-specific training into a format that an application utilizing character recognition technique can read and process efficiently.

### SUMMARY

Various embodiments of the present disclosure provide methods and systems for efficiently capturing, tracking, processing, and managing training records and documents associated with each employee at a workplace.

In an embodiment, a computer-implemented method for managing documents is disclosed. The method performed by a processor includes receiving the documents associated with an employee of a workplace through a document management application available in a user device associated with an employee admin of the workplace. The method includes extracting a first set of data attributes from the documents associated with the employee using one or more character recognition techniques. The one or more character recognition techniques including an Optical Character Recognition (OCR) technique and Intelligent Character Recognition (ICR) technique. The method further includes facilitating displaying the first set of data attributes entered in corresponding data fields rendered in the document management application. Further, the method includes receiving a second set of data attributes based at least on inputs provided by the employee admin in corresponding data fields rendered in the document management application. The method includes generating a user profile for the employee in the document management application based at least on the first and second set of data attributes.

In another embodiment, an application server for managing documents of employees at a workplace is disclosed. The application server includes a communication interface, a memory storing executable instructions, and a processor operatively coupled with the communication interface and the memory. The processor is configured to execute the executable instructions to cause the application server to at least receive the documents associated with an employee of a workplace through a document management application available in a user device associated with the employee admin. The processor is configured to extract first set of data attributes from the documents associated with the employee using one or more character recognition techniques. The one or more character recognition techniques including an Optical Character Recognition (OCR) technique and Intelligent Character Recognition (ICR) technique. The processor is further configured to upon extracting the first set of data attributes, facilitate displaying of the first set of data attributes entered in corresponding data fields rendered in the document management application. Further, the processor is configured to receive a second set of data attributes based at least on inputs provided by the employee admin in corresponding data fields rendered in the document management application. The processor is configured to generate a user profile for the employee in the document management application based at least on the first and second set of data attributes.

In yet another embodiment, a computer-implemented method for managing documents associated with employees working at a workplace is disclosed. The method performed by a processor includes receiving the documents associated with an employee of the workplace through a document management application available in a user device associated with an employee admin of the workplace. Further, receiving the documents from the employee admin includes at least one of receiving the documents in the form of image data from the document management application. The image data is being captured using an image capturing module of the user device associated with the employee admin. Furthermore, receiving the documents from the employee admin includes facilitating a user interface in the document management application for allowing the employee admin to upload the documents that are in form of electronic media. The method includes extracting a first set of data attributes from the documents associated with the employee using one or more character recognition techniques. The one or more character recognition techniques including an Optical Character Recognition (OCR) technique and Intelligent Character Recognition (ICR) technique. Further, the method includes facilitating displaying of the first set of data attributes entered in corresponding data fields rendered in the document management application. The method further includes receiving a second set of data attributes based at least on inputs provided by the employee admin in corresponding data fields rendered in the document management application. The method includes generating a user profile for the employee in the document management application based at least on the first and second set of data attributes.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a simplified block diagram of an application server used for tracking, processing, and managing documents associated with employees at a workplace, in accordance with one embodiment of the present disclosure;

FIG. 3 illustrates an example representation of a user interface (UI) displaying a login page, in accordance with an example embodiment of the present disclosure;

FIGS. 4A, 4B, and 4C, collectively, represent example representation of UIs for receiving the documents of the employees, in accordance with an example embodiment of the present disclosure;

FIGS. 5A, 5B, and 5C, collectively, represent example representation of UIs for enabling an employee admin to create a reference document for all workplace-specific documents, in accordance with an example embodiment of the present disclosure;

FIGS. 6A, 6B and 6C, collectively, represent example representation of user UIs for enabling the employee admin to manage and track the documents associated with each employee, in accordance with an example embodiment of the present disclosure;

FIG. 7 illustrates an example representation of a UI depicting a report transmitted to the employee admin, in accordance with an example embodiment of the present disclosure;

FIG. 8 illustrates a flow diagram of a computer-implemented method for managing documents associated with each employee working at the workplace, in accordance with an embodiment of the present disclosure; and

FIG. 9 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. However, it will be apparent to one skilled in the art that the present disclosure can be practiced without these specific details. Descriptions of well-known components and processing techniques are omitted to not obscure the embodiments herein unnecessarily. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described, which may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other or in conjunction with each other, one skilled in the art will appreciate that many of these features can be provided independently of other features. Accordingly, this description of the present disclosure is set forth without any loss of generality to and without imposing limitations upon the present disclosure.

### Overview

Various example embodiments of the present disclosure provide methods and systems for efficiently capturing, tracking, processing, and managing training records and/or documents associated with each employee at a workplace. In at least one embodiment, the present disclosure provides an application server including a processor operatively coupled with a memory to execute instructions stored in the memory to track, process, and manage the documents associated with the employee at the workplace. The processor is configured to receive the documents associated with the employee working at the workplace through a document management application available in a user device associated with an ‘employee admin’ of the workplace. In one scenario, the employee admin may scan or capture the documents using the user device. Thereafter, the document management application processes the documents as the image data and transmits the image data to the application server. In another scenario, the employee admin may upload the documents that are in electronic media in the document management application. Further, the processor extracts a first set of data attributes from the documents using one or more character recognition techniques. The one or more character recognition techniques include an Optical Character Recognition (OCR) technique and Intelligent Character Recognition (ICR) technique. Upon extracting the first set of data attributes, the processor auto-fills the first set of data attributes in data fields rendered in the document management application. Additionally, the processor receives a second set of data attributes based at least on inputs provided by the employee admin in corresponding data fields rendered in the document management application. The second set of data attributes may be the data attributes that are unable to be extracted using the character recognition technique or maybe the additional information that is not present in the documents. Thereafter, the processor generates a user profile for the employee in the document management application based at least on the first and second set of data attributes.

In addition, the processor is configured to track an expiry status associated with the documents of the employee based at least on the first and second data attributes and displays the expiry status associated with each document of the employee in the document management application. In an embodiment, the processor is configured to transmit a report to at least one user of the document management application. Specifically, the processor receives input from the employee admin related to a frequency and contact details of at least one user of the document management application. The report is generated by including the user profile of each employee at the workplace and the expiry status of the documents associated with each employee. The report is further transmitted to the at least one user based at least on the frequency set by the employee admin. Further, the processor is configured to create a reference document for all workplace-specific documents for enabling the document management application to easily extract relevant data from the reference document.

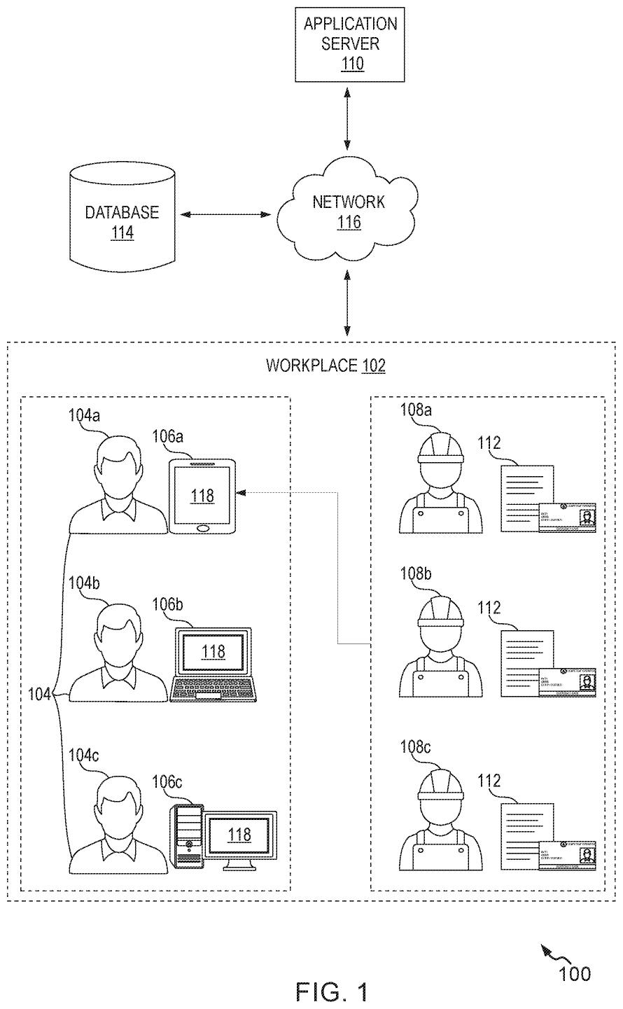

Various embodiments of the present invention are described hereinafter with reference to FIG. 1 to FIG. 9.

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 is depicted to include a workplace 102. The term ‘workplace’ as used herein may refer to a worksite such as an industry, a construction site, a mining site or any corporate company, public or private sector enterprise, and the like.

The workplace 102 is further depicted to include at least one user 104 exemplarily depicted as a user 104a, a user 104b, and a user 104c. The at least one user 104 may be a representative of the workplace 102. For instance, the user 104a may be an employee admin of the workplace 102, and the user 104b maybe a project manager, and the user 104c may be a supervisor of a particular project carrying out at the workplace 102. For illustration purposes, only three users are shown for explaining the embodiments of the present disclosure, and there can be any number of users. The user 104a is hereinafter interchangeably referred to as ‘the employee admin 104a’ or the ‘admin 104a’. The employee admin 104a is an individual who is responsible for the processing of records and/or documents in the workplace 102.

The environment 100 further depicts staff or a group of workers or employees exemplarily depicted as an employee 108a, an employee 108b, and an employee 108c. The employees 108a-108c may be an individual who is employed, for example, as a crane operator, pressure equipment, rigging in an industry. The employees 108a-108c may be employed on a temporary basis or contract basis for various projects in the workplace 102. Furthermore, the employees may be engaged in any number of ways, such as, but not limited to, a consultancy or subcontractor basis. The term ‘employee’ for the purposes of illustration shall include all these various definitions that workers may be engaged. Generally, each of the employees 108a-108c is required to carry necessary documents and/or training records (see, 112) to the workplace 102 for inspection or onboarding to work on a particular project at the workplace 102. Furthermore employees may be required to bring new training documents, partake in new training or receive worksite specific training at any time whilst carrying our activities for their employer. The documents 112 associated with each of the employees 108a-108c may be a work license, entry tickets, workplace-specific documents, and qualifications and training certificates.

Further, the users 104a-104c are associated with respective user devices such as a user device 106a, a user device 106b and a user device 106c, respectively. The user devices 106a-106c associated with the users 104a-104c are exemplarily depicted to be a tablet computer, a laptop and a computer, respectively. The user devices 106a-106c are capable of connecting to a communication network, such as a network 116, for communicating with each other, and the user devices 106a-106c may be embodied as any electronic device capable of facilitating communication with external entities. Some non-limiting examples of the electronic device may include a laptop computer, a smartphone, a desktop computer, a workstation terminal, a personal digital assistant, a wearable device, or in general, any computing device capable of Web access. The network 116 may include wired networks, wireless networks, and combinations thereof. Some non-limiting examples of the wired networks may include Ethernet, local area networks (LANs), fiber-optic networks, and the like. Some non-limiting examples of wireless networks may include cellular networks like GSM/3G/4G/5G/LTE/CDMA networks, wireless LANs, Bluetooth, Wi-Fi or ZigBee networks, and the like. An example of a combination of wired and wireless networks may include the Internet.

In one embodiment, the user devices 106a-106c are equipped with an instance of a document management application 118 (hereinafter interchangeably referred to as ‘the application 118’). The application 118 is a set of computer-executable codes configured to provide user interfaces (UIs) to the users 104a-104c for tracking, processing, and managing the documents 112 associated with each of the employees 108a-108c, which will be explained further in detail. The application 118 may be hosted and managed by an application server 110. In an embodiment, the application server 110 may provide the application 118 in response to a request received from each of the user devices 106a-106c via the network 116. In another embodiment, the application 118 may be factory-installed on the user devices 106a-106c. In some embodiments, the application server 110 may provide application services as a web service accessible through a website. In such a scenario, the application 118 may be accessed through the website over the network 116 using web browser applications installed in the user device (e.g., the user device 106a).

In addition, the application server 110 should be understood to be embodied in at least one computing device in communication with the network 116, which may be specifically configured, via executable instructions, to perform as described herein, and/or embodied in at least one non-transitory computer-readable media.

In the illustrative embodiment, the admin 104a collects the documents 112 from the employee (e.g., the employee 108a) while onboarding at the workplace 102 or at another appropriate time. More specifically, the admin 104a may access the application 118 in the user device 106a for uploading the documents 112 associated with the employee (e.g., the employee 108a). In one scenario, the documents 112 may be of a tangible form (i.e., a card, or a paper document). In this scenario, the admin 104a accesses the application 118 available in the user device 106a for capturing an image of the documents 112 or scanning the documents 112. It will be apparent to a person skilled in the art that the documents 112 are captured using an image capturing module (not shown in Figures) of the user device 106a.

The captured image is processed in the application 118. More specifically, the application 118 extracts relevant information from the image data of the documents 112 upon scanning the documents 112. It is to be noted that the application 118 is configured with one or more character recognition techniques such as an Optical Character Recognition (OCR) technique and Intelligent Character Recognition (ICR) technique for extracting the required and relevant information from the image data of the documents 112. Thereafter, a user profile is created for the employee 108a in the application 118 based on the extraction of the relevant information from the documents 112. Further, the user profile is stored in a database 114 associated with the application server 110 and is made accessible to users such as the admin 104a, and the users 104b and 104c of the application 118. In an embodiment, the admin 104a may upload the documents 112 that is in form of an electronic format (e.g., a portable document format (PDF)) in the application 118. Similarly, the application 118 extracts the relevant information from the electronic documents.

In an embodiment, the application server 110 is configured to track an expiry status of the documents 112 associated with each of the employees 108a-108c. The application 118 is configured to send relevant reports at regular intervals to the admin 104a or the users 104b, 104c. Further, the application 118 automatically highlights the expiry status of the documents 112 on both the reports and in the user profile of each of the employees 108a-108c in the application 118.

In an alternative embodiment, the application server 110 embodied in a device is configured to create a user profile for an employee 108a-108c based on one or more sets of data attributes associated with documents of the employees, tracking and managing the documents associated with user profiles. The application server 110 is configured to collect or capture image data of one or more documents. The captured image data is processed by the application server 110, to identify the relevant information associated with the employees 108a-108c, extract the relevant information associated with the employees 108a-108c, classify the exacted information into at least a set of data attributes also known as the first set of data attributes. It is to be noted that the the application server 110 is configured with one or more character recognition techniques such as an Optical Character Recognition (OCR) technique and Intelligent Character Recognition (ICR) technique for extracting the required and relevant information from the image data of the documents 112. The first set data attributes extracted are auto-filled and displayed to the user on a user device.

Further, the application server 110 receives a second set of data attributes based at least on the inputs received from the admin in response to a request to enter or manually input additional information of the documents associated with the employees 108a-108c by the admin. The second set of data attributes correspond to data relevant to the documents 112 associated with the employees 108a-108c that are unable to be extracted by the character recognition techniques. The application server 110, then collates the first set of data attributes and the second set of data attributes associated with the document provided by the employees 108a-108c to generate a user profile with the expiry status of the documents 112 associated with each of the employees 108a-108c.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of the environment 100 may perform one or more functions described as being performed by another set of systems or another set of devices of the environment 100.

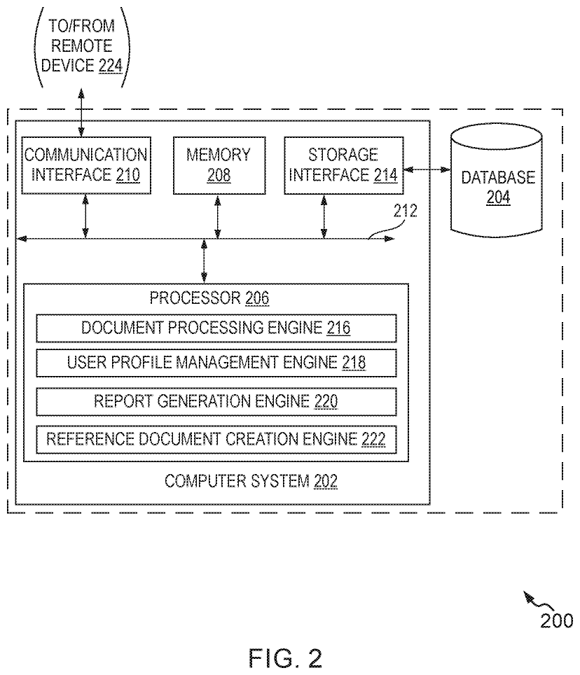

FIG. 2 illustrates a simplified block diagram of an application server 200 used for tracking, processing, and managing the documents 112 associated with the employees 108a-108c at the workplace 102, in accordance with one embodiment of the present disclosure. Examples of the application server 200 include, but are not limited to, the application server 110 as shown in FIG. 1.

The application server 200 includes a computer system 202 and a database 204. The computer system 202 includes at least one processor 206 for executing instructions, a memory 208, a communication interface 210, and a storage interface 214. The one or more components of the computer system 202 communicate with each other via a bus 212. The components of the application server 200 provided herein may not be exhaustive, and the application server 200 may include more or fewer components than those depicted in FIG. 2. Further, two or more components may be embodied in one single component, and/or one component may be configured using multiple sub-components to achieve the desired functionalities.

In one embodiment, the database 204 is integrated within the computer system 202 and configured to store an instance of the document management application 118 and one or more components of the application 118. The one or more components of the application 118 maybe, but are not limited to, information related to user inputs, user profiles associated with each of the employees, reports, reference documents, and the like. The computer system 202 may include one or more hard disk drives as the database 204. The storage interface 214 is any component capable of providing an access to the database 204 to the processor 206. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute computer-readable instructions for performing security investigation and response analysis. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In some embodiments, the memory 208 may be realized in the form of a database server or cloud storage working in conjunction with the server system 200 without deviating from the scope of the present disclosure. In some embodiments, the memory 208 may be realized in the form of a database server or cloud storage working in conjunction with the server system 200 without deviating from the scope of the present disclosure.

The processor 206 is operatively coupled to the communication interface 210 such that the processor 206 is capable of communicating with a remote device 224 such as the user devices 106a-106c or with any entity connected to the network 116 as shown in FIG. 1.

In one embodiment, the processor 206 includes a document processing engine 216, a user profile management engine 218, a report generation engine 220, and a reference document creation engine 222. As such, the one or more components of the processor 206 as described above are communicably coupled with the application 118 and configured to process, track and manage the documents 112 associated with the employees 108a-108c at the workplace 102.

The document processing engine 216 includes a suitable logic and/or interface for processing the documents 112 received as the image data and extracts relevant information from the image data of the documents 112. The document processing engine 216 processes the documents 112 into two fundamental operations such as processing the image data of the documents 112 and processing external sources of data. The document processing engine 216 receives the documents 112 as the input through the application 118.

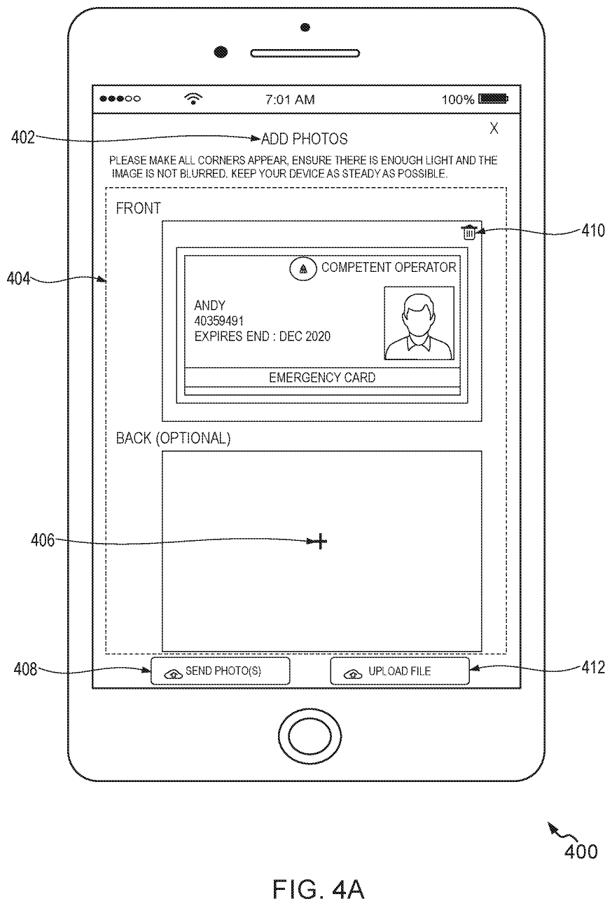

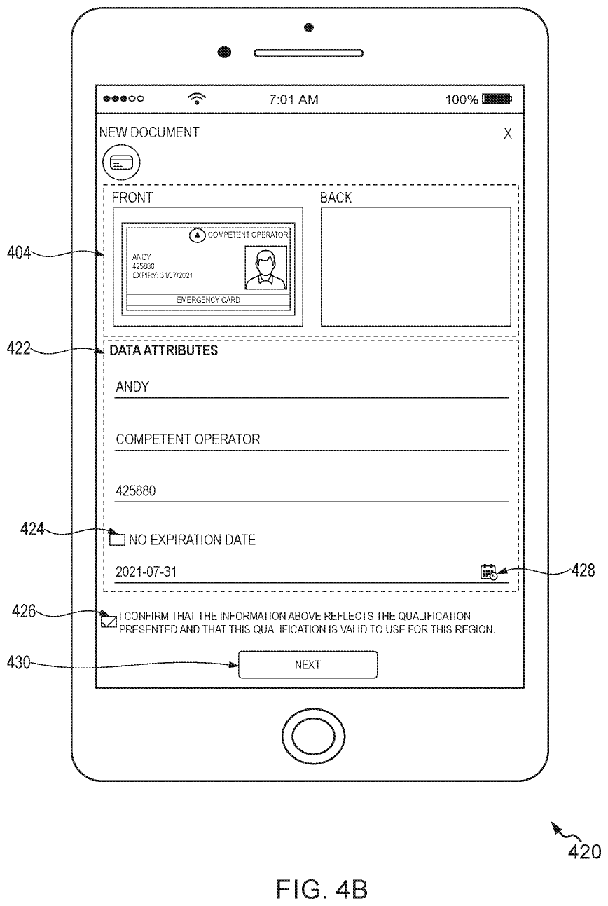

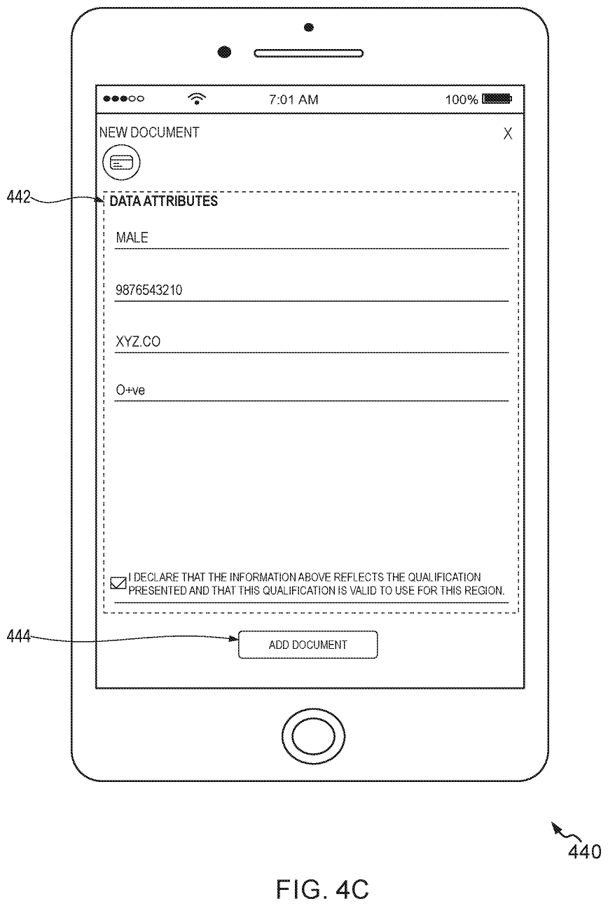

As explained above, the employees 108a-108c are required to present the documents 112 to the admin 104a at suitable times such as, but not limited to, while onboarding to a specific project at the workplace 102. The admin 104a associated with the user device 106a accesses the application 118 for updating the documents 112 associated with each of the employees 108a-108c in the application 118. In an example scenario, the documents 112 submitted by the employee 108a may be in a tangible form (e.g., entry tickets, a workplace-specific document, and a work license card). In this case, admin 104a is rendered with a user interface (as shown in FIG. 4A) in the application 118 for allowing the admin 104a to capture or scan the documents 112 associated with the employee 108a. The document management engine 216 processes the captured image data of the documents 112. In another example scenario, admin 104a may receive the documents 112 from the employee 108a in form of electronic media (i.e. electronic documents, for example, the PDF copy of the documents 112). In this case, the admin 104a may upload the electronic media of the documents 112 in the application 118. The document processing engine 216 is configured to extract the image data from the electronic media of the documents 112.

Thereafter, the document processing engine 216 facilitates the application 118 to extract the first set of data attributes from the documents 112 associated with the employee 108a using one or more character recognition techniques. The one or more character recognition techniques comprising an Optical Character Recognition (OCR) technique and Intelligent Character Recognition (ICR) technique. The application 118 with the character recognition functionality (i.e., OCR functionality) configured to extract the first set of data attributes (or relevant text or data) from the documents 112. The first set of data attributes may be relevant parts, or the data attributes that can be extracted by the document processing engine 216 using the OCR technique. For instance, the document may be the work license of the employee 108a, and the relevant information extracted from the work license may be one of a worker name, license type, expiry date, and license number. In this example scenario, the worker name, license type, expiry date, and license number represent the first set of data attributes that are extracted from the work license of the employee 108a by the document processing engine 216 using the OCR functionality. Upon extracting, the document processing engine 216 facilitates displaying of the first set of data attributes entered in corresponding data fields in the application 118.

Further, the document processing engine 216 receives a second set of data attributes based at least on the inputs provided by the admin 104a in corresponding data fields rendered in the application 118. The second set of data attributes correspond to data relevant to the documents 112 associated with the employee 108a that are unable to be extracted by the OCR technique. In other words, the second set of data attributes constitute the data that may be present in the documents 112 that are unable to be extracted using the OCR technology, or the data may not be present in the documents 112. As such, the data is entered manually by the admin 104a in the corresponding data fields rendered in the application 118. For instance, the second set of data attributes may be, but are not limited to, the company the employee works for, designation of the employee, emergency contact details, and the like. Thereafter, the document processing engine 216 collates the first set of data attributes and the second set of data attributes associated with the particular document (e.g., the work license) provided by the employee 108a.

Additionally, the document processing engine 216 external sources of data as explained above. For instance, the external sources may be a site access system. The document processing engine 216 receives information related to the entry and exit of each of the employees 108a-108c based at least on using the entry tickets at the site access system. Further, the external source data and the data associated with the documents 112 of the employees 108b and 108c and are extracted and processed in a similar manner as explained above.

The user profile management engine 218 includes a suitable logic and/or interface for creating and managing user profiles of each of the employees 108a-108c at the workplace 102. Specifically, the user profile management engine 218 receives the first and second set of data attributes and creates a user profile for each of the employees 108a-108c in the document management application 118. In addition, the user profile management engine 218 is configured to track an expiry status associated with the documents 112 of each of the employees 108a-108c based at least on the first and second data attributes. More specifically, the user profile management engine 218 tracks the expiry status of the documents 112 and provides insights to the admin 104a in the application 116, if the documents 112 are in date, expiring soon, or expired. The user profile management engine 218 may indicate the expiry status associated with each of the documents 112 in the application 118 through a color-coding system.

In an embodiment, the user profile management engine 218 may update the reporting time of each of the employees 108a-108c at the workplace 102 in the application 118 based at least on receipt of the data associated with the site access system from the document processing engine 216. This allows the admin 104a to track the presence of the employee at the workplace 102.

The report generation engine 220 includes a suitable logic and/or interface for generating and transmitting a report to at least the admin 104a and the users 104b and 104c. Specifically, the admin 104a may provide an input related to a frequency (e.g., weekly or monthly) and contact details of the admin 104a in the application 116. The report generation engine 220 generates the report comprising the user profile of each of the employees 108a-108c at the workplace 102 and the expiry status of the documents 112 associated with each of the employees 108a-108c based on encountering the desired frequency set by the admin 104a in the application 118. Thereafter, the report generation engine 220 transmits the report to the contact details (e.g., an email address) associated with the admin 104a. For instance, the report generated may be circulated in the form of an attachment (either in an excel format or a pdf format) to the email address of the admin 104a. Additionally, the admin 104a may provide the contact details of the users 104b and 104c, who are the project managers or supervisors of the project carried out at the workplace 102 in which the employees 108a-108c are deployed. In this scenario, the report generation engine 220 transmits the report to the project managers and the supervisors (i.e. the users 104b and 104c) at the desired frequency (either weekly or monthly), for enabling the users 104b and 104c to access and track the documents 112, reporting time associated with each of the employees 108a-108c.

The reference document creation engine 222 includes a suitable logic and/or interface for creating a reference document of the workplace-specific document. Specifically, the admin 104a can create the reference document for the workplace-specific documents by providing inputs in the application 118. The reference document refers to a standardized document format for all the workplace-specific documents.

In general, the workplace-specific documents refer to the documents created by the companies for the employee deployed to particular tasks at the workplace 102. In other words, the workplace-specific document are issued to the employees 108a-108c by the admin 104a while onboarding to a project at the workplace 102 or at other times such as when new work tasks are created or amended. Some non-limiting examples of the workplace-specific documents may include, but not limited to, safe/standard operating procedures, method statements, inductions, safety notices, risk assessments, and the like. These documents are generally created in electronic format, for example, a Microsoft word document, and often printed out to facilitate delivery and communication to employees (e.g., the employees 108a-108c) at the workplace 102.

The reference document creation engine 222 receives the workplace-specific document as the input through the application 118. In particular, the admin 104a uploads the workplace-specific document (in the electronic format) in the application 118. Thereafter, the reference document creation engine 222 receives a third set of data attributes through the application based on the inputs provided by the admin 104a in the application 118. The third set of data attributes may include one of a document type, a document title, an expiry date, and approvers and reviewers. Typically, the admin 104a provides input or select certain properties including the document type, the document title, the expiry date, and approvers and reviewers who have access to the same project in the application 118. Thereafter, the reference document creation engine 222 is configured to extract a fourth set of data attributes from the workplace-specific documents. The fourth set of data attributes includes at least one of project details, workplace details, and a document creator's name. Further, the reference document creation engine 222 generates the reference document based at least on the third and fourth set of data attributes. In other words, the reference document creation engine 222 auto-fills the third and fourth set of data attributes in the application 118 and generates the reference document of the workplace-specific document. It should be understood that the reference document is the document that logs the contents of the workplace-specific document.

In addition, the reference document creation engine 222 creates a header wrapper for the reference document based at least on the third and fourth set of data attributes, a document reference number, a document creation date, and a document status. It is to be noted that the reference document is created in a standardized format that is compatible to download and/or print out documents. The standardized format of the reference document allows the admin 104a or any users or employees at the workplace 102 to refer to the key data of the reference document by referring to the header wrapper of the reference document. Further, the reference document is automatically stored in a document manager associated with the document management application, upon assigning at least the document reference number and the document creation date. It will be apparent that the present disclosure shows one form of standardized ‘header’ but this can apply equally to any number of other formats where this key information is captured and displayed on a document in a manner that enables a computer application to automatically capture and process required information.

Furthermore, the document processing engine 216 extracts the relevant data from the reference document by referring to the header wrapper, when the reference document is uploaded in the application 118 by the admin 108a while onboarding the employee 108a to the project at the workplace 102. To that effect, the reference document corresponds to an OCR-ready document.

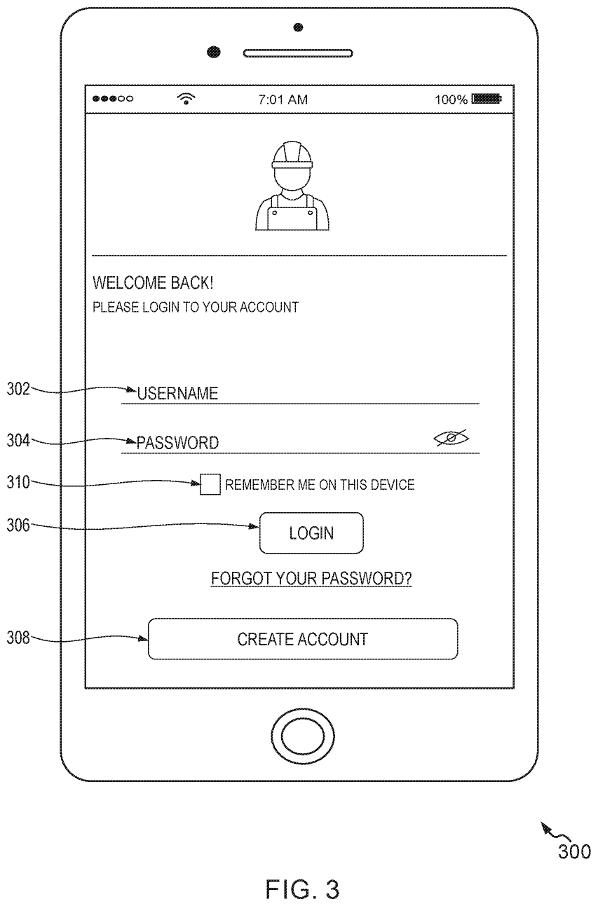

Referring to FIG. 3, an example representation of a user interface (UI) 300 displaying a login page is illustrated, in accordance with an example embodiment of the present disclosure. The UI 300 is depicted by the application 118 upon accessing the application 118 in the user device 106a. As shown, the UI 300 is depicted to include an input field 302 and an input field 304 for receiving login credentials such as an email address and a password, respectively. It is to be understood that the admin 104a should undergo a one-time registration process in the application 118 by providing details such as the email address, name, and the like. The admin 104a may register for the application 118 by providing input on a button 308 associated with the text ‘CREATE ACCOUNT’. In an embodiment, the admin 104a may register for the application 118 using a mobile phone number. Upon registering, the admin 104a enters the email address and the password in the input fields 302 and 304, respectively for accessing the application 118. Thereafter, the admin 104a clicks a button 306 associated with the text ‘LOGIN’. The admin 104a is provided access to the application 118 based upon successful verification of the login credentials. Additionally, the UI 300 is depicted to include a dialog box 310. The admin 104a clicks on the dialog box 310 for enabling auto-fill of the login credentials in the input fields 302 and 304 while logging into the application 118 at future instances. Upon accessing the application 118, the admin 104a is rendered with user interfaces (UIs) in the application 118 for uploading, processing, tracking and managing the documents 112 associated with the employees at the workplace which are explained further in detail.

FIGS. 4A, 4B and 4C, collectively represent example representation of user interfaces (UIs) for receiving the documents 112, in accordance with an example embodiment of the present disclosure.

Referring to FIG. 4A, an example representation of a UI 400 for capturing the documents 112 is illustrated. The UI 400 is rendered by the application 118 at the user device 106a based on selection of an option associated with capturing of the documents 112 in the application 118. In other words, the admin 104a provides an input on an option for uploading new documents associated with the employee (e.g., the employee 108a) in the application 118. The UI 400 is depicted to include a title 402 associated with the text ‘ADD PHOTOS’. Further, the UI 400 depicts at least one image data field 404 for receiving each side of a document (exemplarily depicted to be ‘Front’ and ‘Back’).

The admin 104a uploads the document 112 in the application by providing input on an actionable icon 406 (depicted in each image data field 404). Upon providing input on the actionable icon 406, the image capturing module of the user device 106a associated with the admin 104a is triggered for capturing the documents 112. For instance, the document provided by the employee may be the work license. The admin 104a provides input on the actionable icon 406 for capturing the front side of the work license. It will be apparent for a person skilled in the art that the front side of the work license or any document generally contains the generic and technical data of the employee. Upon capturing, the application 118 processes the document (i.e. the work license of the employee) as the image data and preview the captured image data (exemplarily depicted to be the image data of the front side of the work license) in one of the image data field 404 assigned for the front side of the document in the UI 400. Further, the admin 104a may delete the captured image data by providing input on an actionable icon 410 which will be depicted in each image data field 404 upon preview of the image data in the image data field 404. Thereafter, the admin 104a clicks a button 408 associated with the text ‘SEND PHOTOS’ for transmitting the image data of the document to the application server 200 for extracting the first set of data attributes from the captured image data which will be explained further in detail.

Further, the documents (e.g., the work license or qualification certificates) associated with the employee that are in the form of electronic media can be uploaded in the application 118 based on providing inputs on a button 412 in the UI 400. Based on providing input on the button 412, the admin 104a may be directed to a UI (not shown in Figures) for selecting the file or documents from a local storage of the user device 106a.

Referring to FIG. 4B, the admin 104a is directed to a UI 420, upon uploading the image data or the electronic media of the document. In one example scenario, the UI 420 is depicted to include the image data field 404 depicting the captured image data of the work license. Further, the application 118 configured with the character recognition functionality such as the OCR functionality extracts a first set of data attributes 422 (exemplarily depicted to be employee name, designation, registration number, and expiry date) from the document (i.e. the work license). Upon extracting, the first set of data attributes 422 are automatically entered in corresponding data fields rendered in the UI 420. The UI 420 is depicted to include a dialog box 424 associated with the text ‘No expiration date’. The application 118 provides input in the dialog box 424 based on detecting absence of the expiry date in the document provided by the employee. In an embodiment, the admin 104a may manually enter and/or select the expiry date of the document by providing input on an actionable icon 428.

Thereafter, the admin 104a verifies and confirms the first set of data attributes 422 entered in the UI 420 and provides an input in a dialog box 426. The input in the dialog box 426 confirms the consent of the admin 104a about the first set of data attributes 422. The admin 104a may amend any of the data attribute of the first set of data attributes in the UI 420, if the admin 104a determines the data attribute automatically entered by the application 118 is incorrect.

Referring to FIG. 4C, the admin 104a is directed to a UI 440 based on providing input on a button 430 rendered in the UI 420. The UI 440 is depicted to include a plurality of data fields for receiving a second set of data attributes 442 associated with the employee. The second set of data attributes 442 are exemplarily depicted to be a gender of the employee, emergency contact details, the company or organization the employee works for, a blood group and declaration of the employee. The admin 104a is required to manually enter the second set of data attributes 442 in corresponding data fields rendered in the UI 440. Upon entering, the admin 104a logs the first and second set of data attributes 422 and 442 in the application 118 by providing input on a button 444. In other words, the application 118 creates a user profile for the employee based at least on the first and second set of data attributes 422 and 442, upon providing input on the button 444. This allows the admin 104a to manage and/or track the documents of the employee by referring to user profile of the employee in the application 118 which will be explained further in detail.

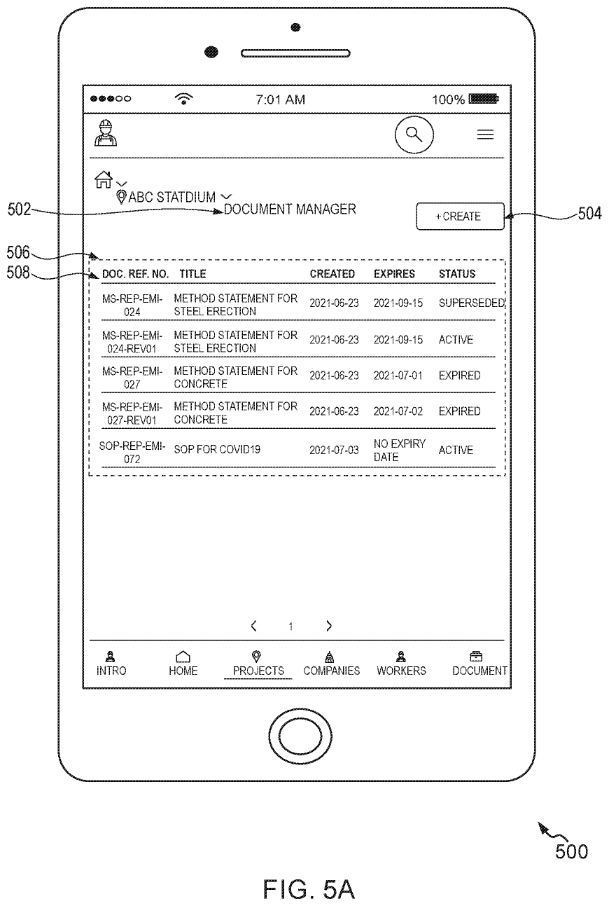

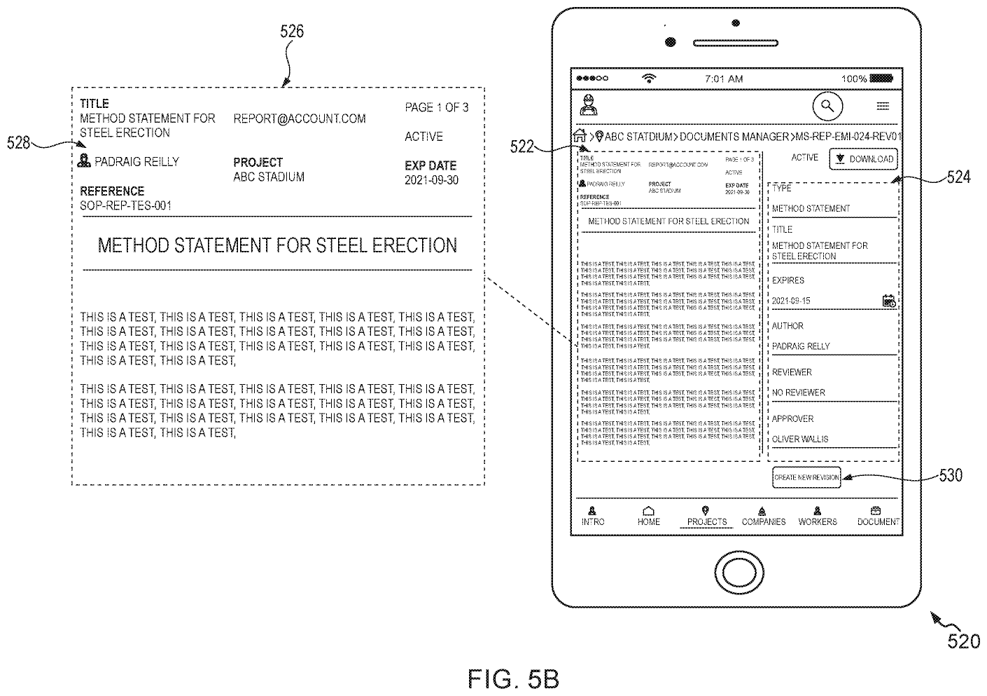

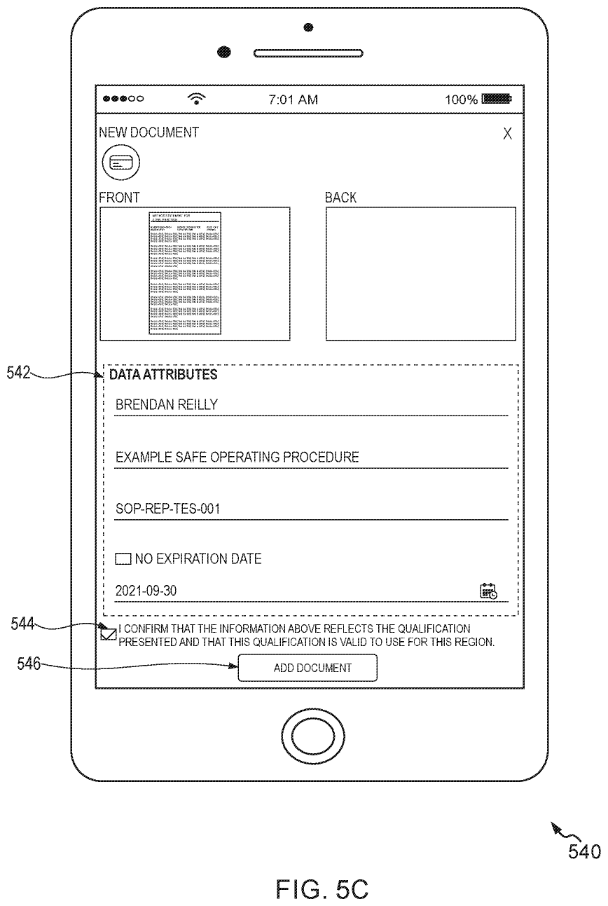

FIGS. 5A, 5B and 5C, collectively represent example representation of user interfaces (UIs) for enabling the admin 104a to create a reference document for all the workplace-specific documents, in accordance with an example embodiment of the present disclosure.

Referring to FIG. 5A, an example representation of a UI 500 depicting a document manager 502 is illustrated. The UI 500 is depicted to include a button 504 associated with the text ‘CREATE’. The admin 104a may be rendered with a UI (not shown in Figures) for uploading the workplace-specific document in compatible formats (for example, the pdf file) based on providing input on the button 504. Upon uploading, the admin 104a may be allowed to create a reference document from the workplace-specific document in the application 118.

It is to be noted that the reference document is in a standardized format predefined in the application 118. This enables the admin 104a to convert all the workplace-specific documents that are in an infinite number of bespoke formats to the standardized format, thereby allowing the OCR technology of the application 118 to capture and process the required data from all the reference documents. The admin 104a is directed to a UI 520 (as shown in FIG. 5B) for converting all the workplace-specific documents to the standardized format (i.e. the reference document).

Referring now to FIG. 5B, the UI 520 is depicted to include a reference document section 522. The reference document section 522 is depicted to include the standardized format of the reference document. Further, the UI 520 is depicted to include data fields for receiving a third set of data attributes 524. In other words, the admin 104a manually enters the third set of data attributes 524 in the corresponding data fields of the UI 520. The third set of data attributes 524 may include, but are not limited to a document type, a document title, an expiry date, and approvers and reviewers for reviewing the document. In an example scenario, the approvers and reviewers may be the users 104b and 104c who are the managers or the supervisors of the project where the employees 108a-108c. Further, the application 118 is configured to extract a fourth set of data attributes from the workplace-specific document using the one or more character recognition techniques. The fourth set of data attributes may include, but are not limited to, project details, workplace details, and a document creator's name extracted from the workplace-specific document. Thereafter, the application 118 generates the reference document by populating the third set of data attributes 524 and the fourth set of data attributes in the standardized format of the reference document depicted in the reference document section 522. Thus, it is evident that the admin 104a can create a document that logs the workplace-specific document within the application 118 and enables an easy way to store the reference documents.

Additionally, the application 118 is configured to create a header wrapper (see, 528 in a magnified portion 526 of FIG. 5B) for the reference document. The header wrapper 528 includes at least the third set of data attributes 524 and the fourth set of data attributes, the document reference number, the document creation date and a document status. The document status is assigned based at least approval from the approvers and reviewers of the reference document. It is to be understood that the document status is pending (as shown in the magnified portion 526), during creation of the reference document or until the receipt of approval from the approvers and reviewers of the reference document. Thereafter, the reference document is stored in the document manager 502 associated with the document management application 118.

As shown in FIG. 5A, the UI 500 is depicted to include a list of reference documents 506 stored in the document manager 502. The list of reference documents 506 refer to the documents that are previously created and stored in the application 118. It should be noted that a relevant information 508 is depicted for each reference document of the list of reference documents 506 stored in the document manager 502. The relevant information 508 corresponds to one of the document creation date, the expiry date, and the document status and the title of the document. The relevant information 508 of each of the reference documents 506 provides reference to the admin 104a for selecting the particular document, while creating the document for the new employee.

The admin 104a is directed to the UI 520 based on selection of the reference document from the document manager 502. In this scenario, the admin 104a may revise or update the reference document based on the data associated with the particular employee of the workplace 102. The admin 104a may create an updated or revised reference document of the already created reference document by providing inputs in corresponding data fields depicted in the UI 520 as explained above. Upon providing the inputs, the admin 104a creates the revised or updated reference document for issuing to a particular employee (e.g., the employee 108b) by clicking on a button 530 in the UI 520.

The employee 108b may provide the documents (e.g., the reference document, the work card license, the qualification and training certificates etc.) while onboarding to the project at the workplace 102 or at other suitable times as explained above. In this scenario, the admin 104a captures or scans each side of the reference document using the application 118 similar to the work card license as explained above. As shown in FIG. 5C, the application 118 processes each side of the reference document to the image data and uploads in the application 118 (exemplarily depicted to be front side of the reference document). Thereafter, the application 118 configured with OCR functionality extracts data attributes 542 (exemplarily depicted to be the document creator name, the title of the document, the document reference number and the expiry date) from the reference document and automatically enters in corresponding data fields as explained above. More specifically, the application 118 refers to the header wrapper (such as the header wrapper 528) of the reference document for extracting the relevant information from the image data of the reference document. Thereafter, the application 118 logs the reference document in the user profile of the employee based on receiving the confirmation from the admin 104a. In other words, the admin 104a verifies the data attributes 542 filled in the data fields, and provides input in a dialog box 544 depicted in the UI 540. The input in the dialog box 544 corresponds to the confirmation of the admin 104a. Thereafter, the application 118 logs the reference document in the user profile of the employee, upon the admin 104a provides the input on a button 546 (as shown in FIG. 5C).

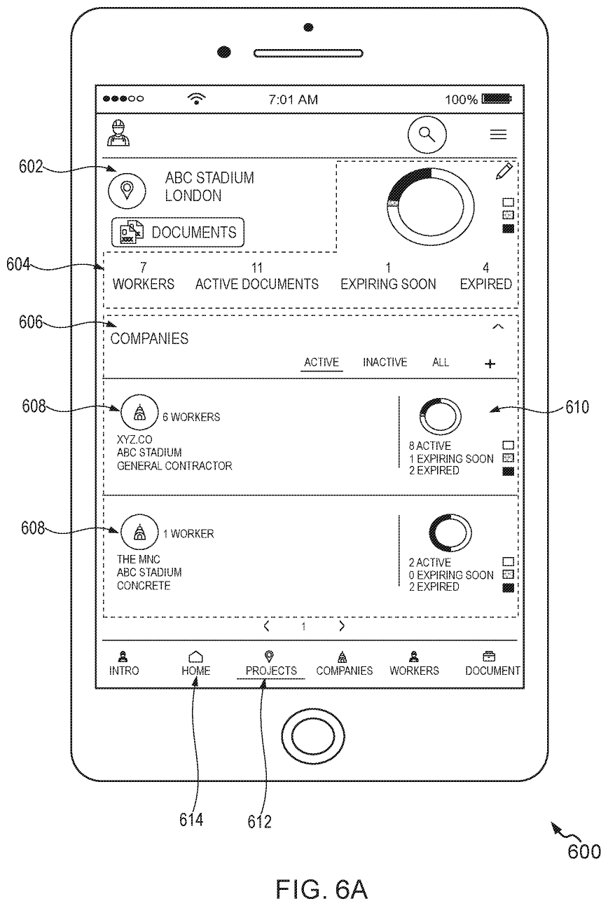

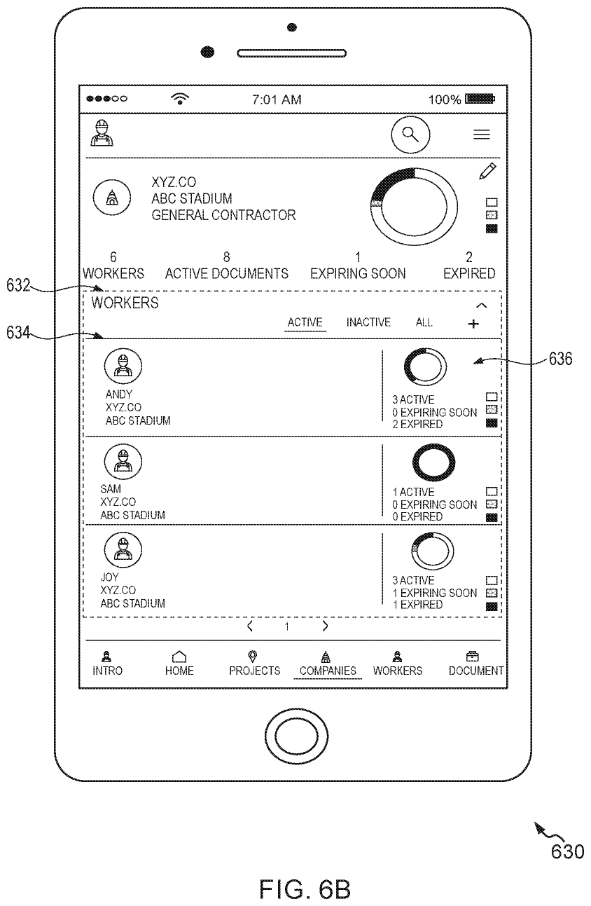

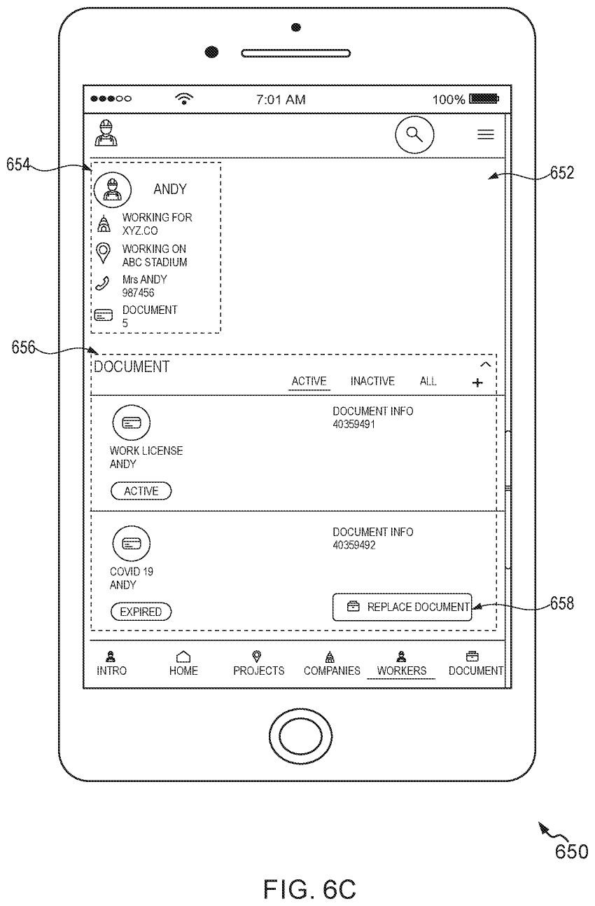

FIGS. 6A, 6B and 6C, collectively represent example representation of user interfaces (UIs) for enabling the admin 104a to manage and track the documents 112 associated with each of the employees 108a-108c of the workplace 102, in accordance with an example embodiment of the present disclosure.

Referring to FIG. 6A, the admin 104a is provided with a UI 600 depicting the details of the workplace. More specifically, the admin 104a may click on a button 612 associated with the text ‘PROJECTS’ for accessing the UI 600 in the application 118. Further, the admin 104a may access all the projects (or the workplace) that are logged in the application 118 by providing input on a button 614 in the application 118. In other words, the admin 104a may be provided with a UI (not shown in Figures) depicting a list of workplace or projects that are managed by the admin 104a, upon successful authentication of the login credentials. It should be understood that the admin 104a is provided with the UI 600 based on selection of a workplace from the list of workplace.

The UI 600 is depicted to include a workplace details section 602, and a first employee and document summary section 604. It is evident that the workplace details section 602 includes the details associated with the workplace such as, a location of the workplace, and address of the workplace. Further, the first employee and document summary section 604 is exemplarily depicted to include a total number of workers (or employees) at the workplace, and a document status (exemplarily depicted to be active, expiring soon and expired) associated with the documents of the total number of workers. The workers may be employed in different companies and are deployed to the workplace for working on the particular project at the workplace.

The UI 600 is further depicted to include a company details section 606. The company details section 606 depicts one or more companies 608 in which the workers are employed, and a first document status section 610. The first document status section 610 is depicted to include the status (such as active, expiring soon and expired) of the documents associated with the workers of each of the companies 608. For instance, a company exemplarily depicted to be ‘XYZ.CO’ includes 6 workers who are deployed at the workplace ‘ABC STADIUM’ as general contractor' (as shown in FIG. 6A). Further, the document status associated with the total number of workers (6 workers) of the company ‘XYZ.CO’ is exemplarily depicted to be ‘8 active, ‘1 expiring soon’ and ‘2 expired’ in the first document status section 610. For illustration purpose the document status of the total number of workers at the workplace and the total number of workers of each company working at the workplace are depicted using a status bar in the employee and document summary section 604 and the first document status section 610, respectively. It is to be noted that the status bar is provided with different hatch pattern for representing the active, expiring soon, and expired status of the documents.

Referring now to FIG. 6B, the admin 104a is rendered with a UI 630 based on selection of a company from the one or more companies 608. The company selected by the admin 104a is exemplarily depicted to include ‘XYZ.CO’. The UI 630 allows the admin 104a to track the documents of the workers (or the employees) of the company who are working at the workplace 102. It is to be noted that the details of the company that are depicted in the company details section 606 is depicted in the UI 630 based on selection of the company. Further, the UI 630 is depicted to include workers section 632. The workers section 632 is depicted to include one or more workers 634 employed in the company and working at the workplace and a second document status section 636. For instance, a worker exemplarily depicted to be ‘ANDY’ of ‘XYZ.CO’ is deployed at the workplace ‘ABC STADIUM’ as the general contractor' (as shown in FIG. 6B). Further, the document status associated with the documents of the worker is exemplarily depicted to be ‘3 active, ‘0 expiring soon’ and ‘2 expired’ in the second document status section 636. The admin 104a may track the documents associated with each worker by providing selection input on any of worker from the workers 634 which is explained with reference to FIG. 6C.

Referring now to FIG. 6C, the admin 104a is provided with a UI 650 depicting a user profile 652 of the worker based on selection of a worker from the workers 634 in the UI 630. The user profile 652 associated with the worker is depicted to include an employee details 654 and a documents section 656. The employee details 654 is exemplarily depicted to include a name of the employee (or the worker), company of the employee, the workplace, contact details, and the number of documents. The documents section 656 is depicted to include the documents associated with worker. Further, the admin 104a may view each of the document by providing input on the document associated with the employee. In this scenario, the application 118 may render a UI (not shown in Figures) depicting the document details based on selection of a particular document from the documents section 656. Additionally, the application 118 renders a button 658, if the document is determined to be expired (as shown in FIG. 6C). In this scenario, the admin 104a replaces the document by providing an input on the button 658. In other words, the admin 104a may be provided with the UI 400 for either uploading the electronic media of the document or capturing the document as explained above.

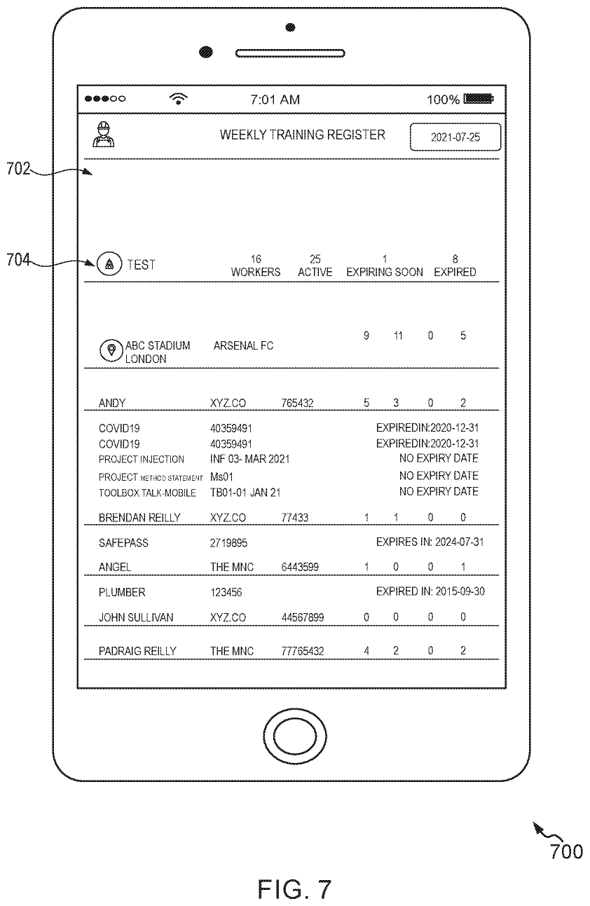

FIG. 7 illustrates an example representation of a UI 700 depicting a report 702 generated by the application 118, in accordance with an example embodiment of the present disclosure. As explained above, the report 702 is generated at regular intervals (i.e. based on the frequency set by the admin 104a). The report 702 is transmitted to the admin 104a and the users 104b and 104c based at least the contact details provided by the admin 104a in the application 118. The report 702 is depicted to include a second employee and document summary section 704. The second employee and document summary section 704 depicts information such as total number of workers working on different projects (or the workplace), and the documents' status associated with each worker of the total number of workers working on different projects. The report 702 is generated based at least on the details of the workplace details section 602, and the first employee and document summary section 604. Further, the report 702 includes the user profile of each employee at the workplace and the expiry status of the documents associated with each employee. The details depicted in the report 702 is already explained above with reference to FIGS. 6A-6C, and therefore they are not reiterated for the sake of brevity.

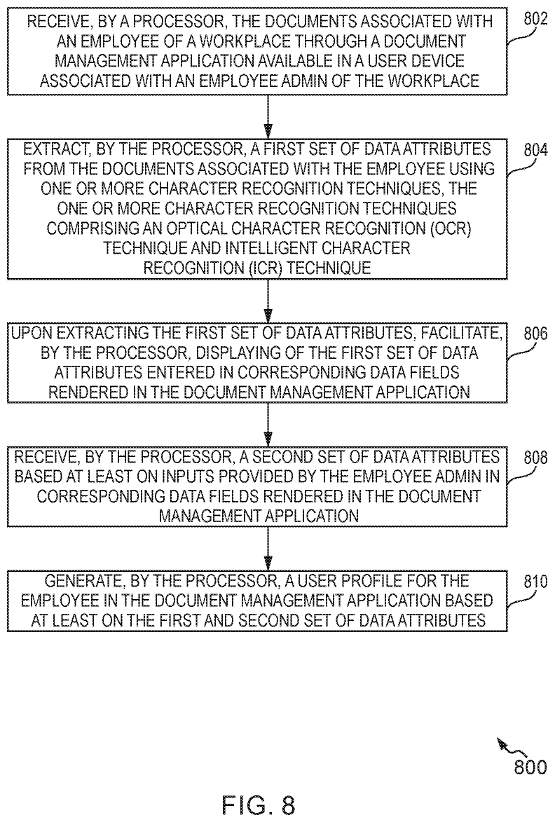

FIG. 8 illustrates a flow diagram of a computer-implemented method 800 for managing documents associated with each employee 108a-108c working at the workplace 102, in accordance with an embodiment of the present disclosure. The method 800 depicted in the flow diagram may be executed by, for example, the processor 206 of the application server 200. Operations of the flow diagram of the method 800, and combinations of operation in the flow diagram of the method 800, maybe implemented by, for example, hardware, firmware, a processor, circuitry, and/or a different device associated with the execution of software that includes one or more computer program instructions. It is noted that the operations of the method 800 can be described and/or practiced by using a system other than these server systems. The method 800 starts at operation 802.

At operation 802, the method 800 includes receiving, by a processor, the documents associated with an employee of a workplace through a document management application available in a user device associated with an employee admin of the workplace.

At operation 804, the method 800 includes extracting, by the processor, a first set of data attributes from the documents associated with the employee using one or more character recognition techniques. The one or more character recognition techniques including an Optical Character Recognition (OCR) technique and Intelligent Character Recognition (ICR) technique.

At operation 806, the method 800 includes upon extracting the first set of data attributes, facilitating, by the processor, displaying of the first set of data attributes entered in corresponding data fields rendered in the document management application.

At operation 808, the method 800 includes receiving, by the processor, a second set of data attributes based at least on inputs provided by the employee admin in corresponding data fields rendered in the document management application.

At operation 810, the method 800 includes generating, by the processor, a user profile for the employee in the document management application based at least on the first and second set of data attributes. The user profile including the data related to the employee is stored in a database (e.g., the database 204). The users (such as the admin 104a or the users' 104b and 104c) can access and view the user profile of each employee at the workplace 102 through a Graphical user interface (GUI) on their respective user devices as explained above. Further, the process of tracking, collecting, processing managing the documents of the employee are already explained above, and therefore they are not reiterated, for the sake of brevity.

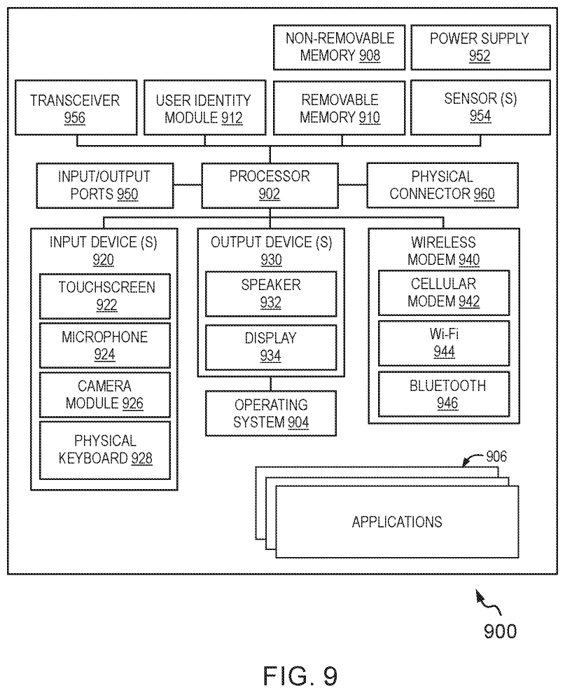

FIG. 9 is a simplified block diagram of an electronic device 900 capable of implementing various embodiments of the present disclosure. For example, the electronic device 900 may correspond to the user devices 106a-106c of FIG. 1. The electronic device 900 is depicted to include one or more applications 906. For example, the one or more applications 906 may include the application 118 of FIG. 1. The application 118 can be an instance of a document management application provided by the application server 110 or the application server 200. One of the one or more applications 906 installed on the electronic device 900 are capable of communicating with an application server system for tracking, processing and managing the documents associated with each employee working at the workplace such as the workplace 102.

It should be understood that the electronic device 900 as illustrated and hereinafter described is merely illustrative of one type of device and should not be taken to limit the scope of the embodiments. As such, it should be appreciated that at least some of the components described below in connection with the electronic device 900 may be optional and thus in an embodiment may include more, less or different components than those described in connection with the embodiment of the FIG. 9. As such, among other examples, the electronic device 900 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the electronic device 900 and supports for one or more operations of the application (see, the applications 906), such as the application 118 that implements one or more of the innovative features described herein. In addition, the applications 906 may include common mobile computing applications (e.g., telephony applications, email applications, calendars, contact managers, web browsers, messaging applications) or any other computing application.

The illustrated electronic device 900 includes one or more memory components, for example, a non-removable memory 908 and/or removable memory 910. The non-removable memory 908 and/or the removable memory 910 may be collectively known as a database in an embodiment. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904 and the applications 906. The electronic device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to, a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the electronic device 900 and a public switched telephone network (PSTN).

The electronic device 900 can further include one or more input/output ports 950, a power supply 952, one or more sensors 954 for example, an accelerometer, a gyroscope, a compass, or an infrared proximity sensor for detecting the orientation or motion of the electronic device 900 and biometric sensors for scanning biometric identity of an authorized user, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

The disclosed method with reference to FIG. 8, or one or more operations of the application server 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the application server 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for managing documents, the method comprising:
receiving, by a processor, the documents associated with an employee of a workplace through a document management application available in a user device associated with an employee admin of the workplace;
extracting, by the processor, a first set of data attributes from the documents associated with the employee using one or more character recognition techniques, the one or more character recognition techniques comprising an Optical Character Recognition (OCR) technique and Intelligent Character Recognition (ICR) technique;
upon extracting the first set of data attributes, facilitating, by the processor, displaying of the first set of data attributes entered in corresponding data fields rendered in the document management application;
receiving, by the processor, a second set of data attributes based at least on inputs provided by the employee admin in corresponding data fields rendered in the document management application; and
generating, by the processor, a user profile for the employee in the document management application based at least on the first and second set of data attributes.

2. The computer-implemented method as claimed in claim 1, wherein the documents associated with the employee comprise one of a work license, workplace-specific documents, entry tickets and qualification and training certificates.

3. The computer-implemented method as claimed in claim 1, further comprising:
tracking, by the processor, an expiry status associated with the documents of the employee based at least on the first and second data attributes; and
facilitating, by the processor, displaying of the expiry status associated with each of the documents of the employee in the document management application.

4. The computer-implemented method as claimed in claim 1, further comprising:
receiving, by the processor, an input from the employee admin related to a frequency and contact details of at least one user of the document management application; and
transmitting, by the processor, a report comprising the user profile of each employee at the workplace and the expiry status of the documents associated with each employee to the at least one user based at least on the frequency set by the employee admin.

5. The computer-implemented method as claimed in claim 1, wherein receiving the documents from the employee admin comprises at least one of:
receiving the documents in form of an image data from the document management application, the image data being captured using an image capturing module of the user device associated with the employee admin; and
facilitating a user interface in the document management application for allowing the employee admin to upload the documents that are in form of an electronic media.

6. The computer-implemented method as claimed in claim 1, wherein the first set of data attributes comprise one of an employee name, a license type, expiry date and a license number, and wherein the second set of data attributes comprise one of emergency contact details, a job title and a company name where the employee works.

7. The computer-implemented method as claimed in claim 1, further comprising:
receiving, by the processor, a workplace-specific document through the document management application, the workplace-specific document being issued to the employee by the employee admin at the workplace;
receiving, by the processor, a third set of data attributes through the document management application, the third set of data attributes comprising one of a document type, a document title, an expiry date, and approvers and reviewers;
extracting, by the processor, a fourth set of data attributes from the workplace-specific document using the one or more character recognition techniques, the fourth set of data attributes comprising one of project details, workplace details, and a document creator's name extracted from the workplace-specific document;
generating, by the processor, a reference document based at least on the third set of data attributes and the fourth set of data attributes; and
assigning, by the processor, a document reference number, and a document creation date to the reference document.

8. The computer-implemented method as claimed in claim 6, further comprising:
creating, by the processor, a header wrapper for the reference document based at least on the third and fourth set of data attributes, the document reference number, the document creation date and a document status; and
storing, by the processor, the reference document in a document manager associated with the document management application.

9. An application server for managing documents of employee at a workplace, the application server comprising:
a communication interface;
a memory storing executable instructions; and
a processor operatively coupled with the communication interface and the memory, the processor configured to execute the executable instructions to cause the application server to at least:
receive the documents associated with an employee of a workplace through a document management application available in a user device associated with the employee admin,
extract a first set of data attributes from the documents associated with the employee using one or more character recognition techniques, the one or more character recognition techniques comprising an Optical Character Recognition (OCR) technique and Intelligent Character Recognition (ICR) technique,
upon extracting the first set of data attributes, facilitate displaying of the first set of data attributes entered in corresponding data fields rendered in the document management application,
receive a second set of data attributes based at least on inputs provided by the employee admin in corresponding data fields rendered in the document management application, and
generate a user profile for the employee in the document management application based at least on the first and second set of data attributes.

10. The application server as claimed in claim 9, wherein the documents associated with the employee comprise one of a work license, workplace-specific documents, entry tickets and qualification and training certificates.

11. The application server as claimed in claim 9, wherein the application server is further caused to:
track an expiry status associated with the documents of the employee based at least on the first and second data attributes; and
facilitate displaying of the expiry status associated with each of the documents of the employee in the document management application.

12. The application server as claimed in claim 11, wherein the application server is further caused to:
receive an input from the employee admin related to a frequency and contact details of at least one user of the document management application; and
transmit a report comprising the user profile of each employee at the workplace and the expiry status of the documents associated with the each employee to the at least one user based at least on the frequency set by the employee admin.

13. The application server as claimed in claim 9, wherein receiving the documents from the employee admin comprises at least one of:
receive the documents in form of an image data from the document management application, the image data being captured using an image capturing module of the user device associated with the employee admin; and
facilitate a user interface in the document management application for allowing the employee admin to upload the documents that are in form of an electronic media.

14. The application server as claimed in claim 9, wherein the first set of data attributes comprise one of an employee name, a license type, expiry date and a license number, and wherein the second set of data attributes comprise one of emergency contact details, a job title and a company name where the employee works.

15. The application server as claimed in claim 9, wherein the application server is further caused to:
receive a workplace-specific document through the document management application, the workplace-specific document being issued to the employee by the employee admin at the workplace;
receive a third set of data attributes through the document management application, the third set of data attributes comprising one of a document type, a document title, an expiry date, and approvers and reviewers;
extract a fourth set of data attributes from the workplace-specific document using the one or more character recognition techniques, the fourth set of data attributes comprising one of project details, workplace details, and a document creator's name extracted from the workplace-specific document;
generate a reference document based at least on the third set of data attributes and the fourth set of data attributes; and
assign a document reference number, and a document creation date to the reference document.

16. The application server as claimed in claim 15, wherein the application server is further caused to:
create a header wrapper for the reference document based at least on the third and fourth set of data attributes, the document reference number, the document creation date and a document status, wherein the document status is assigned based at least approval from the approvers and reviewers of the reference document; and
store the reference document in a document manager associated with the document management application.

17. A computer-implemented method for managing documents associated with employees working at a workplace, the method comprising:
receiving, by a processor, the documents associated with an employee of the workplace through a document management application available in a user device associated with an employee admin of the workplace, wherein receiving the documents from the employee admin comprises at least one of:
receiving the documents in form of an image data from the document management application, the image data being captured using an image capturing module of the user device associated with the employee admin, and
facilitating a user interface in the document management application for allowing the employee admin to upload the documents that are in form of an electronic media;
extracting, by the processor, a first set of data attributes from the documents associated with the employee using one or more character recognition techniques, the one or more character recognition techniques comprising an Optical Character Recognition (OCR) technique and Intelligent Character Recognition (ICR) technique;
upon extracting the first set of data attributes, facilitating, by the processor, displaying of the first set of data attributes entered in corresponding data fields rendered in the document management application;
receiving, by the processor, a second set of data attributes based at least on inputs provided by the employee admin in corresponding data fields rendered in the document management application; and
generating, by the processor, a user profile for the employee in the document management application based at least on the first and second set of data attributes.

18. The computer-implemented method as claimed in claim 17, further comprising:
tracking, by the processor, an expiry status associated with the documents of the employee based at least on the first and second data attributes; and
facilitating, by the processor, displaying of the expiry status associated with each of the documents of the employee in the document management application.

19. The computer-implemented method as claimed in claim 17, further comprising:
receiving, by the processor, an input from the employee admin related to a frequency and contact details of at least one user of the document management application; and
transmitting, by the processor, a report comprising the user profile of each employee at the workplace and the expiry status of the documents associated with the each employee to the at least one user based at least on the frequency set by the employee admin.

20. The computer-implemented method as claimed in claim 17, further comprising:
receiving, by the processor, a workplace-specific document through the document management application, the workplace-specific document being issued to the employee by the employee admin at the workplace;
receiving, by the processor, a third set of data attributes through the document management application, the third set of data attributes comprising one of a document type, a document title, an expiry date, and approvers and reviewers;
extracting, by the processor, a fourth set of data attributes from the workplace-specific document using the one or more character recognition techniques, the fourth set of data attributes comprising one of project details, workplace details, and a document creator's name extracted from the workplace-specific document;
generating, by the processor, a reference document based at least on the third set of data attributes and the fourth set of data attributes;
creating, by the processor, a header wrapper for the reference document based at least on the third and fourth set of data attributes, the document reference number, the document creation date and a document status;
assigning, by the processor, a document reference number, and a document creation date to the reference document; and
storing, by the processor, the reference document in a document manager associated with the document management application.
